(19) United States
(12) Patent Application Publication
(10) Pub. No.: US 2008/0310866 A1
(43) Pub. Date: Dec. 18, 2008

(54) FUSING UNIT AND IMAGE FORMING APPARATUS INCLUDING THE SAME

(75) Inventor: Dong-kyun Kim, Suwon-Si (KR)

Correspondence Address: DLA PIPER US LLP, P. O. BOX 9271, RESTON, VA, 20195, US

(73) Assignee: SAMSUNG ELECTRONICS CO., LTD., SUWON-SI (KR)

(21) Appl. No.: 12/045,841

(22) Filed: Mar. 11, 2008

(30) Foreign Application Priority Data
Jun. 14, 2007 (KR) 10-2007-0058375

(51) Int. Cl. G03G 15/20

(52) U.S. Cl. 399/33; 399/122; 399/329

(57) ABSTRACT

A fusing unit comprises a heating unit, a first roller and a second roller, at least one of which is heated by the heating unit, a belt which moves along the first roller and the second roller, a roller supporting unit which supports at least one of the first roller and the second roller, and a belt tension control unit which moves at least one of the first roller and the second roller so that the first roller and the second roller can move toward or apart from each other.

### CROSS-REFERENCE TO RELATED APPLICATIONS

This application claims priority from Korean Patent Application No. 10-2007-0058375, filed on Jun. 14, 2007, in the Korean Intellectual Property Office, the disclosure of which is incorporated herein by reference.

### BACKGROUND OF INVENTION

1. Field of Disclosure

The present disclosure relates to printers and, more particularly, to a fusing unit in a printer.

2. Description of the Related Art

An electrophotographic image forming apparatus, e.g., a laser printer may have a number of components, including but not limited to for example, a photosensitive body, a laser scanning unit, and a fusing unit. The laser scanning unit produces an electrostatic latent image of the text/image to be printed on the photosensitive body by scanning a laser beam across the photosensitive body. The electrostatic latent image is then developed by selective application of toner to produce a developed image. The developed toner image is then transferred onto a print medium, e.g., a sheet of paper or the like. The fusing unit fixes the toner image on the print medium by applying heat and pressure to bond toner to the paper.

A fusing unit may generally be classified into a roller type or a belt type. In a roller type fusing unit, a heating roller together with a pressing roller pressing against the heating roller form a fusing nip. The belt type fusing unit may typically form a wider fusing nip.

The belt type fusing unit includes a belt, a pair of rollers which enable the belt to circulate along a desired track, a heating lamp which is disposed inside at least one of the pair of rollers to heat the belt, and a pressing roller which presses against at least one of the pair of rollers across the belt.

While the belt type fusing unit are widely used in electrophotographic image forming apparatus, e.g., a laser printer, it has several shortcomings. For example, if the heating lamp operates abnormally, an excessive heat is transmitted to the belt, and as a result the belt may be damaged. The present disclosure is directed towards overcoming one or more shortcomings of the belt type fusing unit.

### SUMMARY OF THE INVENTION

Accordingly, it is an aspect of the present invention to provide an image forming apparatus minimizing overheating of the belt of the fusing unit, and to thereby improve product life.

The foregoing and/or other aspects of the present invention can be achieved by providing a fusing unit for fixing a toner image onto a medium in an image forming apparatus, including: a first roller and a second roller, a belt disposed around the first roller and the second roller such that a separation distance between the first roller and the second roller defines a level of tension in the belt; and a belt tension adjustment mechanism configured to move, during operation of the image forming apparatus, at least one of the first roller and the second roller to vary the separation distance, and to thereby vary the level of tension in the belt.

According to an aspect of the present invention, the fusing unit further includes a belt tension adjustment mechanism including: a sensor configured to sense the temperature of the belt, a roller movement mechanism configured to move at least one of the first roller and the second roller, and a controller configured to control the roller movement mechanism to move at least one of the first roller and the second roller to reduce the separation distance of the sensed temperature of the belt exceeds a predetermined temperature.

According to another aspect of the present invention, the fusing unit further includes a heating unit disposed inside at least one of the first roller and the second roller that is capable of being moved by the roller movement mechanism, the heating unit supplying heat to the belt.

According to yet another aspect of the present invention, the fusing unit further includes a fusing unit support frame for supporting at least one of the first roller and the second roller, the fusing unit support frame being configured to move with at least one of the first roller and the second roller, in which the heating unit is disposed.

According to even yet another aspect of the present invention, the fusing unit further includes the fusing unit support frame is configured to move along a direction perpendicular to a rotational axis of the first roller.

According to another aspect of the present invention, the fusing unit further includes a roller movement mechanism including: an elastic member configured to apply a bias such that the first roller and the second roller are biased away from each other, and a cam configured to rotate about a cam shaft parallel with a rotational axis of the first roller to presses against at least one of the first roller and the second roller so that at least one of the first roller and the second roller moves in a direction that reduces the separation distance.

According to another aspect of the present invention, the fusing unit further includes a roller movement mechanism including: an elastic member configured to apply a bias such that the first roller and the second roller are biased away from each other, and a rack configured to move at least one of the first roller and the second roller so that at least one of the first roller and the second roller moves in a direction that reduces the separation distance, and a pinion configured to drive the rack.

According to another aspect of the present invention, a method of operating a fusing unit that includes: a belt, a first roller, a second roller and a heating unit, the first roller and the second roller supporting the belt such that a separation distance between the first roller and the second roller defines a level of tension in the belt, the heating unit being disposed in at least one of the first roller and the second roller to supply heat to the belt, the method including sensing a temperature of the belt, determining whether the sensed temperature of the belt exceeds a predetermined temperature, and moving at least one of the first roller and the second roller so that the separation distance is reduced, and to thereby reducing the level of tension in the belt if the sensed temperature of the belt is determined to exceed the predetermined temperature.

According to another aspect of the present invention, the step of moving at least one of the first roller and the second roller including providing an elastic bias such that the first roller and the second roller are biased away from each other, and rotating a cam about a cam shaft parallel with a rotational axis of the first roller to presses against at least one of the first roller and the second roller so that at least one of the first roller and the second roller moves in a direction that reduces the separation distance.

According to another aspect of the present invention, the step of moving at least one of the first roller and the second roller including: providing an elastic bias such that the first roller and the second roller are biased away from each other, and driving a rack with a pinion to move at least one of the first roller and the second roller in a direction that reduces the separation distance.

According to yet another aspect of the present invention, an image forming apparatus includes a toner image forming portion configured to form a toner image on a print medium, a fusing unit for fixing the toner image on the print medium by applying at least one of heat and pressure, wherein the fusing unit includes, a first roller and a second roller, a belt disposed around the first roller and the second roller such that a separation distance between the first roller and the second roller defines a level of tension in the belt, and a belt tension adjustment mechanism configured to move, during operation of the image forming apparatus, at least one of the first roller and the second roller to vary the separation distance, and to thereby vary the level of tension in the belt.

According to another aspect of the present invention, the belt tension adjustment mechanism includes a sensor configured to sense a temperature of the belt, a roller movement mechanism configured to move at least one of the first roller and the second roller, and a controller configured to control the roller movement mechanism to move at least one of the first roller and the second roller to reduce the separation distance, the sensed temperature of the belt exceeds a predetermined temperature.

According to another aspect of the present invention, the fusing unit includes a heating unit disposed inside at least one of the first roller and the second roller that is capable of being moved by the roller movement mechanism, the heating unit supplying heat to the belt.

According to another aspect of the present invention, the fusing unit includes a fusing unit support frame for supporting at least one of the first roller and the second roller, the fusing unit support frame being configured to move with at least one of the first roller and the second roller, in which the heating unit is disposed.

According to another aspect of the present invention, the fusing unit support frame is configured to move along a direction perpendicular to a rotational axis of the first roller.

According to another aspect of the present invention, the roller movement mechanism includes an elastic member configured to apply a bias such that the first roller and the second roller are biased away from each other, and a cam configured to rotate about a cam shaft parallel with a rotational axis of the first roller to presses against at least one of the first roller and the second roller so that at least one of the first roller and the second roller moves in a direction that reduces the separation distance.

According to another aspect of the present invention, the roller movement mechanism includes an elastic member configured to apply a bias such that the first roller and the second roller are biased away from each other, and a rack configured to move at least one of the first roller and the second roller so that at least one of the first roller and the second roller moves in a direction that reduces the separation distance, and a pinion configured to drive the rack.

Additional aspects of the present invention will be set forth in part in the description which follows and, in part, will be obvious from the description, or may be learned by practice of the present invention.

### BRIEF DESCRIPTION OF THE DRAWINGS

The above and/or other aspects of the present disclosure will become apparent and more readily appreciated from the following description of the exemplary embodiments, taken in conjunction with the accompanying drawings, in which:

FIG. 1 is a perspective view of a fusing unit according to an exemplary disclosed embodiment;

FIG. 2 is a schematic plane view of the fusing unit in FIG. 1 in a normal mode state;

FIG. 3 is a schematic cross sectional view of the fusing unit in FIG. 2;

FIG. 4 is a schematic sectional view along line IV-IV in FIG. 2;

FIG. 5 is a schematic plane view in a belt damage preventing mode state of the fusing unit in FIG. 1;

FIG. 6 is a schematic cross sectional view of the fusing unit in FIG. 5;

FIG. 7 is a schematic cross sectional view of a fusing unit according to an alternative exemplary disclosed embodiment;

FIG. 8 is a flow chart of a control method of a fusing unit according to an exemplary disclosed embodiment.

### DETAILED DESCRIPTION OF SEVERAL EMBODIMENTS

Reference will now be made in detail to exemplary embodiments of the present disclosure, examples of which are illustrated in the accompanying drawings, wherein like reference numerals refer to like elements throughout.

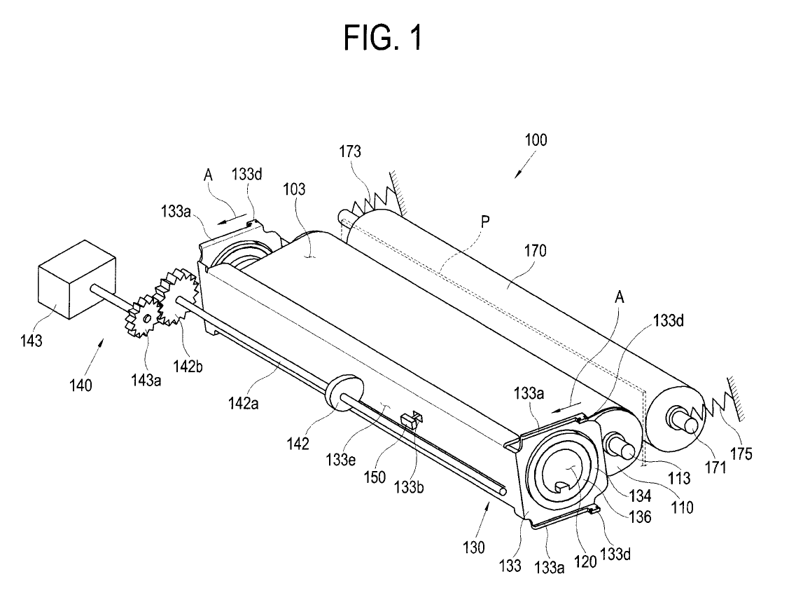

FIG. 1 discloses a fusing unit 100 according to an exemplary disclosed embodiment. As shown in FIG. 1, the fusing unit 100 includes a belt 103, a first roller 110, a second roller 120, a roller supporting unit 130, a belt tension control unit 140, and a sensor 150.

The belt 103 may be provided as a conveyor belt. The belt 103 may also be provided as a polyamide material. Alternatively, the belt 103 may be provided as a thin metal sleeve. the belt 103 circulates along a track in contact with an outer circumferential surface of the first roller 110 and the second roller 120 to be described later. As a pressing roller 170, (which will also be further described later) is driven to rotate, the belt 103 is rotated by the frictional force resulting form the pressure being applied by the pressing roller 170.

The first roller 110 rotates with respect to a first roller shaft 113. The first roller shaft 113 may be rotatably supported on a main body frame of an image forming apparatus (not shown) to which the fusing unit 100 may be mounted.

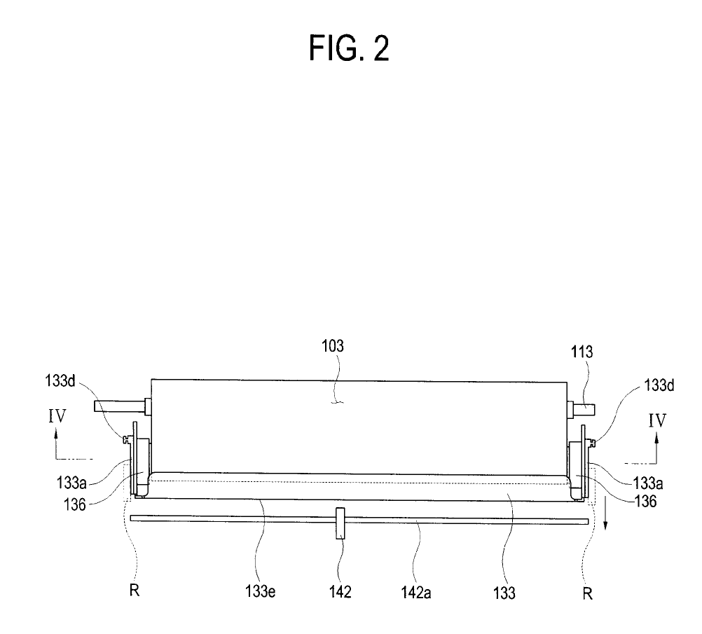

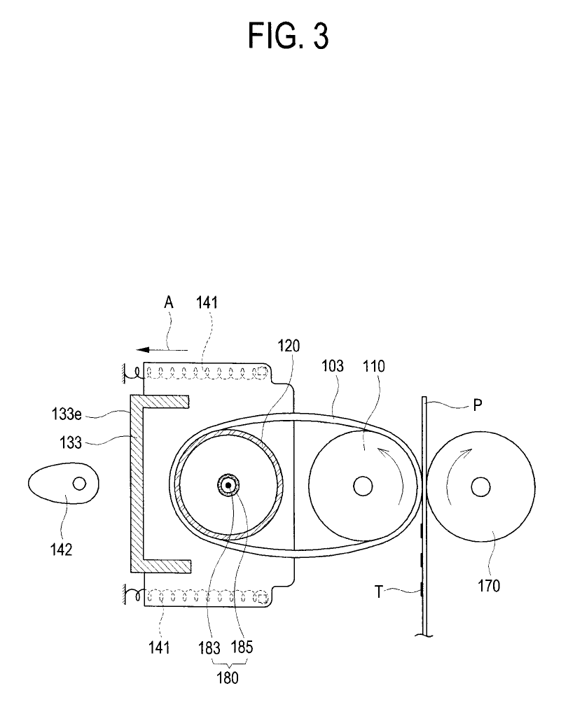

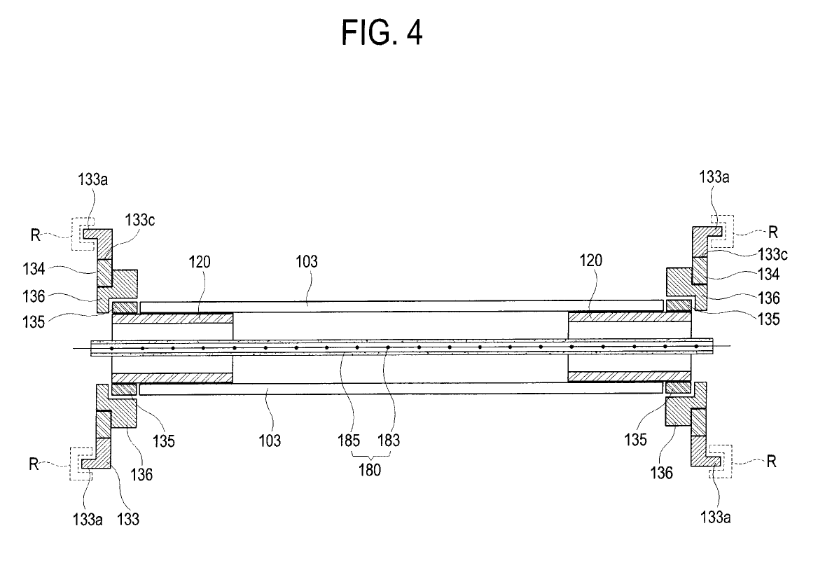

FIG. 2 is a schematic plane view in a normal mode state of the fusing unit in FIG. 1. FIG. 3 is a schematic cross sectional view of the fusing unit in FIG. 2. FIG. 4 is a schematic sectional view along line IV-IV in FIG. 2. As shown in FIG. 4, the second roller 120 may be provided in two separate sections to support the inner circumferential surface of the belt 103 on opposite sides along the direction parallel to the length of the first roller 110. Alternatively, the second roller 120 may be provided as a continuous roller similar to the first roller 110.

Also, the second roller 120 may be rotatably supported by a fusing unit frame 133 to be described later. As shown in FIG. 4, bearings 134 and 135 and a washer 136 may be installed between the fusing unit frame 133 and the second roller 120. The second roller 120 may be rotated by the rotation of belt 103. Alternatively, the second roller 120 may be coupled to the fusing unit frame 133 in such a manner that the second roller 120 does not rotate. In addition, a lubricant may be applied on the contact surfaces of the belt 103 and the second roller 120.

The second roller 120 is configured to move together with the fusing unit frame 133. As shown in FIGS. 1 and 4, the fusing unit frame 133 can move together with the second roller 120 in which a heating lamp 180 (to be described later) may be disposed.

However, the fusing unit frame 133 may alternatively be provided to move together with the first roller 110. That is, the fusing unit frame 133 is provided to move together with at least one of the first and the second roller 110 and 120. While in this embodiment, the heating element, e.g., the heating lamp 180 is shown to be disposed in the second roller 120, it should be readily apparent to those of ordinary skill in the art that, the heating element can also be disposed in the first roller 110 as an alternative.

The heating lamp 180 heats the belt 103. As shown in FIGS. 3 and 4, the heating lamp 180 may include a tubular unit 185 and a heating unit 183. The tubular unit 185 and the heating unit 183 are disposed inside the second roller 120 to emit heat when power is applied to the heating unit 183.

The heating unit 183 may include, e.g., a tungsten filament. A halogen material such as bromine or iodine may be injected inside the tubular unit 185 to suppress the evaporation of the tungsten filament. In addition, the tubular unit 185 may also be made of a transparent glass material so that radiation heat of the heating unit 183 can pass through the tubular unit 185.

As shown in FIGS. 1 and 4, the fusing unit frame 133 includes a guide 133a, a belt temperature sensor opening 133b, a roller supporting opening 133c, and a projection 133d.

As shown in FIG. 4, the guide 133a is provided at upper and lower parts of opposite ends in a lengthwise direction of the fusing unit frame 133. The guide 133a is inserted in a guide rail R of a lateral U-shape. Accordingly, the fusing unit frame 133 can slide along the length of the guide rail R. The guide 133a and the guide rail R may be provided in various shapes as long as they can guide the movement of the fusing unit frame 133. In this embodiment, the guide 133a may extend along a direct perpendicular to the rotational axis of the first roller 110 and/or the second roller 120. In addition, the belt temperature sensor opening 133b is provided on the fusing unit frame 133 so that a sensor 150, which will be described later, can sense the temperature of the belt 103.

As shown in FIG. 4, a bearing 134 is installed in the roller supporting opening 133c. Furthermore, a washer 136 is installed on the inside of the bearing 134. In addition, a bearing 135 may be installed between the washer 136 and the second roller 120.

One end part of an elastic member 141 (FIG. 3) to be described later is connected to the projection 133d. As shown in FIG. 1, the projection 133d may be projected from the guide 133a along the direction parallel to the rotational axis of the second roller 120. The projection 133d may be provided in other shapes, and its position may be changed as long as the elastic member 141 can be coupled thereto.

As shown in FIGS. 1 and 3, the belt tension control unit 140 includes the elastic member 141, a cam 142 and a cam driving unit 143. Furthermore, as shown in FIG. 3, the elastic member 141 applies an elastic force to the fusing unit frame 133 in the direction of the arrow A, biasing the second roller 120 away from the first roller 110. The elastic member 141 biases the second roller 120 and the first roller 110 to move apart from each other so as to maintain the tension of the belt 103 within a predetermined range. One end part of the elastic member 141 may be coupled to the projection 133d of the fusing unit frame 133 and the opposite end part may be coupled to the main body frame (not shown) of the image forming apparatus. In addition, the elastic member 141 may be provided in various shapes and sizes, as long as it can apply the bias such that the first and the second roller 110 and 120 to have the propensity to be apart from each other, without departing from the scope of the disclosure.

The cam 142 is provided to rotate with respect to a cam shaft 142a in a direction parallel to a rotational axis of the first roller 110 or the second roller 120. One end part of the cam shaft 142a is installed on a cam gear 142b. The cam gear 142b is assembled with a pinion 143a of the cam driving unit 143 to receive a rotational force from the cam driving unit 143.

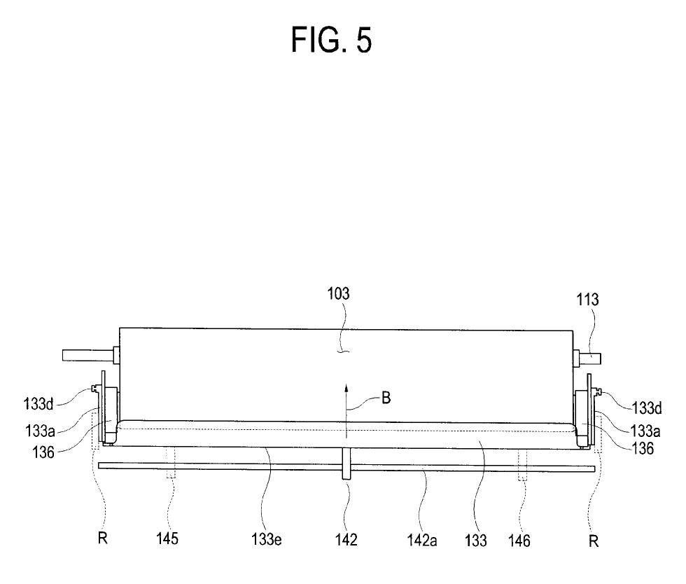

As shown in FIG. 1, the cam 142 is disposed in a position corresponding to a center part of a press contact surface 133e of the fusing unit frame 133. Alternatively, as shown in FIG. 5, the cam 142 may be provided as two separate cams 145 and 146 so as to press opposite sides of the press contact surface 133e. Alternatively, all three cams 142, 145 and 146 may be provided so as to press the different parts of the press contact surface 133e at the same time.

The cam shaft 142a is disposed adjacent to the press contact surface 133e so as to press the press contact surface 133e of the fusing unit frame 133 as the cam 142 rotates. As the cam 142 presses the press contact surface 133e, the second roller 120 moves in a direction approaching the first roller 110. As the second roller 120 so moves, because the tension of the belt 103 is reduced, the contact area between the belt 103 and the outer circumferential surface of the second roller 120 is also reduced. In an exemplary embodiment, the cam driving unit 143 may be provided as, e.g., an electric motor.

In an exemplary embodiment, the sensor 150 may be provided as a thermistor. The sensor 150 is supported by the fusing unit frame 133. The sensor 150 may be disposed in a direction extended toward the belt 103 through the belt temperature sensor opening 133b.

The pressing roller 170 is provided to elastically press a printing medium P toward the first roller 110. Elastic members 173 and 175 may be installed at opposite ends of the pressing roller 170. Elastic members 173 and 175 may be used to elastically bias the pressing roller 170 toward the first roller 110.

Hereinafter, an operating process of the fusing unit 100 with the above configuration will be described by referring to FIGS. 2, 3, 5, and 6. For the sake of clarity, the pressing roller 170 has been omitted from FIGS. 2 and 5.

The fusing unit 100 has a normal mode in which the tension of the belt 103 is maintained at a normal level, and a belt damage preventing mode in which the tension of the belt 103 is maintained at lower than the normal level.

The heat needed for fusing toner T onto the printing medium P is provided by the heating lamp 180. This heat raises the temperature of the belt 103. The controller (not shown) determines whether the temperature of the belt 103 sensed by the sensor 150 is over a predetermined temperature. The predetermined temperature (herein after “belt damage temperature) indicates a temperature which, if exceeded, may cause damage to the belt 103. An upper limit of the fusing temperature range may be preset as the belt damage temperature. In an exemplary embodiment, the belt damage temperature may be empirically determined.

If the temperature of the belt 103 is lower than the belt damage temperature, as shown in FIGS. 2 and 3, the controller (not shown) controls the belt tension control unit 140 according to the normal mode so that the cam 142 does not press against the fusing unit frame 133. Accordingly, the belt 103 surrounds the circumferential outer surface of the second roller 120 with a sufficient tension to transmit the heat from the heating lamp 180. The belt 103 heated to the proper fusing temperature fuses the toner T on the printing medium P passing through the nip between the pressing roller 170 and the belt 103.

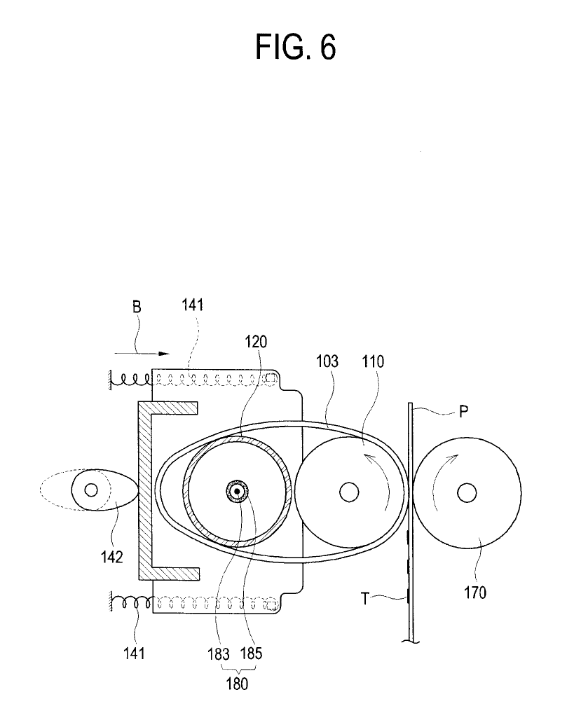

As shown in FIGS. 5 and 6, if the temperature of the belt 103 is over the belt damage temperature, the controller (not shown) controls the belt tension control unit 140 according to the belt damage preventing mode so that the tension of the belt 103 can be relieved in comparison with the normal mode. To this end, the cam 142 is rotated into position to press against the fusing unit frame 133, and to thus move the second roller 120 toward the first roller 110. This in turn overcomes the tension of the elastic member 141, which extends in direction B. By the movement of the second roller 120 in direction B, the contact area between the belt 103 and the circumferential surface of the second roller 120 decreases. Accordingly, the belt can be prevented from being overheated and damaged.

If the tension of the belt 103 is relieved, the temperature of the belt 103 gradually falls down to reach a predetermined tension restoring temperature. When the temperature sensed by the senor 150 reaches the tension restoring temperature, the controller (not shown) controls the belt tension control unit 140 to restore the tension of the belt 103 to the level of the normal mode. For this purpose, the controller can control the cam driving unit 140 for the cam 142 to release the pressure on the press contact surface 133e of the fusing unit frame 133. The tension restoring temperature is lower than the belt damage temperature. In an exemplary embodiment, the lower limit of the fusing temperature range may be set as the tension restoring temperature.

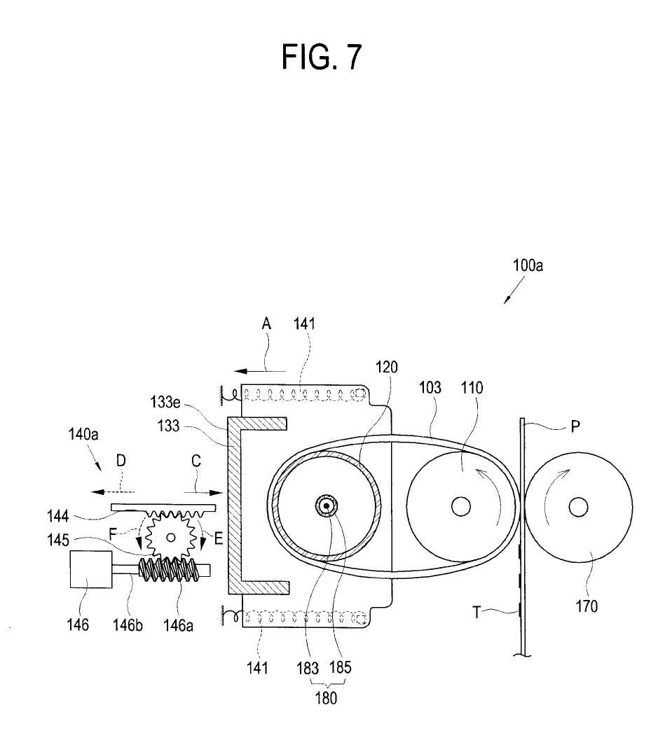

FIG. 7 is a schematic cross sectional view of a fusing unit according to an alternative exemplary disclosed embodiment. As shown in FIG. 7, a fusing unit 100a includes a belt tension control unit 140a. The repeated description of the fusing unit 100a will be omitted as the rest of the configuration of the fusing unit 100a is the same as the fusing unit 100 discussed earlier, except for the belt tension control unit 140a.

The belt tension control unit 140a includes an elastic member 141 which applies an elastic force in the direction A biasing the fusing unit frame 133 away from the first roller 110, a rack 144 which can move forward and backward so as to press and release a press contact surface 133e of the fusing unit frame 133, a pinion 145 which is engaged with the rack 144 to drive the rack 144, and a pinion driving unit 146 which drives the pinion 145.

The pinion driving unit 146 may be provided as an electric motor. The rack 144 moves back and forth in a direction C and D, according to the pinion 145 rotating in a forward direction E and a reverse direction F.

If the pinion is in an idle state, because an elastic force direction A of the elastic member 141 is opposite to the moving direction C of the rack 144, the rack 144 is moved to the direction D by the elastic member 141. Accordingly, if the tension of the belt 103 needs to be relieved, that is, if the temperature of the belt 103 is over the belt damage temperature, the pinion driving unit 146 continuously needs to be supplied with power, or other means may be provided for maintaining the position of the rack 144.

For example, the pinion driving unit 146 may further include a worm gear 146a which is assembled with a driving shaft 146b to be engaged with the pinion 145. Accordingly, the pinion driving unit 146 need not be continuously supplied with power during the time which the temperature of the belt 103 is over the belt damage temperature. That is, although the power supply to the pinion driving unit 146 is stopped after the rack 144 is made to move forward so as to drive the worm gear 146a and relieve the tension of the belt 103, the rack 144 does not retreat by the elastic force of the elastic member 141 as long as the worm gear 146a does not rotate.

The controller (not shown) controls the pinion driving unit 146 so that the worm gear 146a can rotate the pinion 145 in the forward direction E if the belt damage preventing mode is needed, that is, if the temperature of the belt 103 is over the belt damage temperature. Accordingly, the rack 144 moves forward in the direction C to press the fusing unit frame 133, and the second roller 120 approaches toward the first roller 110. Accordingly, the tension of the belt 103 is relieved and the contact area between the second roller 120 and the belt 103 decreases, thereby preventing the belt 103 from being overheated and damaged.

Also, the controller (not shown) can stop the supply of power to the pinion driving unit 146 after the rack 144 has moved forward. In this way, power consumption may be reduced.

The controller (not shown) controls the pinion driving unit 146 so that the worm gear 146a can rotate the pinion 145 in the reverse direction F in the normal mode if the temperature of the belt 103 becomes lower than the belt damage temperature. The controller (not shown) can use the lower limit of the fusing temperature range or any other arbitrary temperature to determine when to change from the belt damage preventing mode to the normal mode.

As the pinion 145 rotates in the reverse direction E, the rack 144 releases the pressure on the fusing unit frame 133, and the tension of the belt 103 is restored to the original state. Accordingly, as the contact area between the belt 103 and the second roller 120 increases, the heat of the heating lamp 180 can be transmitted to the belt 103 normally.

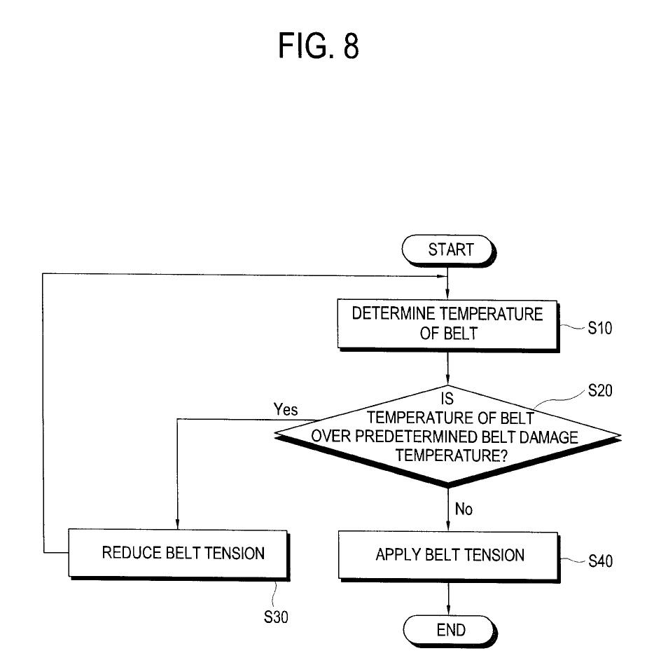

A control method of the fusing unit according to an exemplary disclosed embodiment will now be described by referring to FIG. 8.

First, the temperature of the belt 103 is sensed (S10). Then, it is determined whether the temperature of the belt 103 is over the predetermined belt damage temperature. (S20).

If the temperature of the belt 103 is over the predetermined belt damage temperature, the tension of the belt 103 is reduced to be in a tension-reduced state (S30). That is, if the temperature of the belt 103 is over the predetermined belt damage temperature, the tension of the belt 103 is reduced by, e.g., using the cam 142 of the above-described belt tension control unit 140 or the rack 144. If the tension of the belt 103 was reduced earlier to the tension-reduced state, the reduced tension of the belt 103 is maintained. If, however, the tension of the belt 103 was not earlier reduced to the tension-reduced state, the tension of the belt 103 is reduced in step (S30). As described earlier, the tension of the belt 103 may be reduced by using the cam 142 of the belt tension control unit 140 or the rack 144.

The tension of the belt 103 can be reduced by, e.g., reducing the distance between the first roller 110 and second roller 120. The distance between the first roller 110 and the second roller 120 may be reduced by moving at least one of the first roller 110 and the second roller 120 which circulate the belt 103 along a track. One of the rollers that is disposed with a heating body 183 inside thereof between the first roller 110 and the second roller 120 is preferably moved to separate the heat source from the belt 103.

Accordingly, the tension of the belt 103 is reduced and the contact area between the belt 103 and the heat source is decreased, thereby preventing the belt 103 from being overheated. In addition, until the temperature of the belt 103 drops below the belt damage temperature, the tension-reduced state is maintained (S10)˜(S30).

If the temperature of the belt 103 is lower than the belt damage temperature, the tension of the belt 103 is restored to the normal tension level in step (S40). That is, if the tension of the belt 103 has previously been reduced to the tension-reduced state, the tension is restored to the tension-applied state, and if the tension of the belt 103 had not been reduced, the tension-applied state is maintained.

An application of tension to the belt 103 in the tension-reduced state is possible through releasing the pressing of the above-described cam 142 or the rack 144 on the fusing unit frame 133. Accordingly, the distance of separation between the second roller 120 and the first roller 110 is increased, and the tension is induced in the belt 103.

An image forming apparatus (not shown) according to the present disclosure includes the fusing unit 100 or 100a. The image forming apparatus may also include a photosensitive body (not shown) on which surface an electrostatic latent image is formed, an exposure unit (not shown) which exposes the photosensitive body (not shown) to form the electrostatic latent image, a developing roller (not shown) which develops the photosensitive body (not shown) with toner, and a transferring roller (not shown) which transfers the developed toner image formed on the surface of the photosensitive body (not shown) onto a printing medium. A detailed description of these components is omitted as those are well known to those skilled in the art.

As described above, the fusing unit, the control method thereof and the image forming apparatus may prevent the belt from being overheated and damaged. Although a few exemplary embodiments of the present disclosure have been shown and described, it will be appreciated by those skilled in the art that changes may be made in these embodiments without departing from the principles and spirit of the disclosure, the scope of which is defined in the appended claims and their equivalents.

What is claimed is:

1. A fusing unit for fixing a toner image onto a medium in an image forming apparatus, comprising:
a first roller and a second roller;
a belt disposed around said first roller and said second roller such that a separation distance between said first roller and said second roller defines a level of tension in said belt; and
a belt tension adjustment mechanism configured to move, during operation of said image forming apparatus, at least one of said first roller and said second roller to vary said separation distance, and to thereby vary said level of tension in said belt.

2. The fusing unit according to claim 1, wherein said belt tension adjustment mechanism comprises:
a sensor configured to sense a temperature of said belt;
a roller movement mechanism configured to move said at least one of said first roller and said second roller; and
a controller configured to control said roller movement mechanism to move said at least one of said first roller and said second roller to reduce said separation distance said sensed temperature of said belt exceeds a predetermined temperature.

3. The fusing unit according to claim 2, further comprising:
a heating unit disposed inside said at least one of said first roller and said second roller that is capable of being moved by said roller movement mechanism, said heating unit supplying heat to said belt.

4. The fusing unit according to claim 3, further comprising:
a fusing unit support frame for supporting at least one of the first roller and the second roller, said fusing unit support frame being configured to move with said at least one of said first roller and said second roller, in which said heating unit is disposed.

5. The fusing unit according to claim 4, wherein said fusing unit support frame is configured to move along a direction perpendicular to a rotational axis of said first roller.

6. The fusing unit according to claim 2, wherein said roller movement mechanism comprises:
an elastic member configured to apply a bias such that said first roller and said second roller are biased away from each other; and
a cam configured to rotate about a cam shaft parallel with a rotational axis of said first roller to presses against at least one of said first roller and said second roller so that said at least one of said first roller and said second roller moves in a direction that reduces said separation distance.

7. The fusing unit according to claim 2, wherein said roller movement mechanism comprises:
an elastic member configured to apply a bias such that said first roller and said second roller are biased away from each other; and
a rack configured to move at least one of said first roller and said second roller so that said at least one of said first roller and said second roller moves in a direction that reduces said separation distance; and
a pinion configured to drive said rack.

8. A method of operating a fusing unit that includes a belt, a first roller, a second roller and a heating unit, said first roller and said second roller supporting said belt such that a separation distance between said first roller and said second roller defines a level of tension in said belt, said heating unit being disposed in at least one of said first roller and said second roller to supply heat to said belt, said method comprising:
sensing a temperature of said belt;
determining whether said sensed temperature of said belt exceeds a predetermined temperature; and
moving at least one of said first roller and said second roller so that said separation distance is reduced, and to thereby reducing said level of tension in said belt if said sensed temperature of said belt is determined to exceed said predetermined temperature.

9. The method set forth in claim 8, said step of moving said at least one of said first roller and said second roller comprises:
providing an elastic bias such that said first roller and said second roller are biased away from each other; and
rotating a cam about a cam shaft parallel with a rotational axis of said first roller to presses against at least one of said first roller and said second roller so that said at least one of said first roller and said second roller moves in a direction that reduces said separation distance.

10. The method set forth in claim 8, said step of moving said at least one of said first roller and said second roller comprises:
providing an elastic bias such that said first roller and said second roller are biased away from each other; and
driving a rack with a pinion to move at least one of said first roller and said second roller in a direction that reduces said separation distance.

11. An image forming apparatus comprising:
a toner image forming portion configured to form a toner image on a print medium;
a fusing unit for fixing said toner image on said print medium by applying at least one of heat and pressure, wherein said fusing unit comprises,
a first roller and a second roller;
a belt disposed around said first roller and said second roller such that a separation distance between said first roller and said second roller defines a level of tension in said belt; and
a belt tension adjustment mechanism configured to move, during operation of said image forming apparatus, at least one of said first roller and said second roller to vary said separation distance, and to thereby vary said level of tension in said belt.

12. The image forming apparatus according to claim 11, wherein said belt tension adjustment mechanism comprises:
a sensor configured to sense a temperature of said belt;
a roller movement mechanism configured to move said at least one of said first roller and said second roller; and
a controller configured to control said roller movement mechanism to move said at least one of said first roller and said second roller to reduce said separation distance said sensed temperature of said belt exceeds a predetermined temperature.

13. The image forming apparatus according to claim 11, wherein said fusing unit further comprises:
a heating unit disposed inside said at least one of said first roller and said second roller that is capable of being moved by said roller movement mechanism, said heating unit supplying heat to said belt.

14. The image forming apparatus according to claim 11, wherein said fusing unit further comprises:
a fusing unit support frame for supporting at least one of the first roller and the second roller, said fusing unit support frame being configured to move with said at least one of said first roller and said second roller, in which said heating unit is disposed.

15. The image forming apparatus according to claim 14, wherein said fusing unit support frame is configured to move along a direction perpendicular to a rotational axis of said first roller.

16. The image forming apparatus according to claim 12, wherein said roller movement mechanism comprises:
an elastic member configured to apply a bias such that said first roller and said second roller are biased away from each other; and
a cam configured to rotate about a cam shaft parallel with a rotational axis of said first roller to presses against at least one of said first roller and said second roller so that said at least one of said first roller and said second roller moves in a direction that reduces said separation distance.

17. The image forming apparatus according to claim 12, wherein said roller movement mechanism comprises:
an elastic member configured to apply a bias such that said first roller and said second roller are biased away from each other; and
a rack configured to move at least one of said first roller and said second roller so that said at least one of said first roller and said second roller moves in a direction that reduces said separation distance; and
a pinion configured to drive said rack.
